(19) United States
(12) Patent Application Publication
(10) Pub. No.: US 2012/0156661 A1
(43) Pub. Date: Jun. 21, 2012

(54) METHOD AND APPARATUS FOR GROSS MOTOR VIRTUAL FEEDBACK

(75) Inventors: David Alan Smith, Cary, NC (US); Randel A. Crowe, Interlachen, FL (US)

(73) Assignee: LOCKHEED MARTIN CORPORATION, Orlando, FL (US)

(21) Appl. No.: 12/969,901

(22) Filed: Dec. 16, 2010

(51) Int. Cl. G09B 19/00

(52) U.S. Cl. 434/219

(57) ABSTRACT

An exoskeleton that typically provides human power and endurance augmentation is adapted for use with a simulator system that generates a virtual environment by accepting and processing commands from the simulator to implement gross motor virtual feedback in which some motions of the exoskeleton's wearer (called the “pilot”) are constrained by the exoskeleton to simulate the interaction of the pilot with virtual objects in the virtual environment. In this way, the pilot can interact with virtual objects generated by the simulator system not only visually but through touch as well. For example, a pilot in a combat simulation can move along a virtual wall by feel while maintaining cover from enemy fire and perform actions like pushing virtual objects to clear obstacles from a path.

### BACKGROUND

Increased capabilities in computer processing, such as improved real-time image and audio processing, have aided the development of powerful training simulators such as vehicle, weapon, and flight simulators, action games, and engineering workstations, among other simulator types. Simulators are frequently used as training devices which permit a participant to interact with a realistic simulated environment without the necessity of actually going out into the field to train in a real environment. For example, different simulators may enable a live participant, such as a police officer, pilot, or tank gunner to acquire, maintain, and improve skills while minimizing costs, and in some cases, the risks and dangers that are often associated with live training.

Current simulators perform satisfactorily in many applications. However, customers for simulators, such as branches of the military, law enforcement agencies, industrial and commercial entities, etc., have expressed a desire for more realistic and immersive simulations so that training effectiveness can be improved. In addition, simulator customers typically seek to improve the quality of the simulated training environments supported by simulators by increasing realism in simulations and finding ways to make the simulated experiences more immersive.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An exoskeleton that typically provides human power and endurance augmentation is adapted for use with a simulator system that generates a virtual environment by accepting and processing commands from the simulator to implement gross motor virtual feedback in which some motions of the exoskeleton's wearer (called the “pilot”) are constrained by the exoskeleton to simulate the interaction of the pilot with virtual objects in the virtual environment. In this way, the pilot can interact with virtual objects generated by the simulator system not only visually but through touch as well. For example, a pilot in a combat simulation can move along a virtual wall by feel while maintaining cover from enemy fire and perform actions like pushing virtual objects to clear obstacles from a path. In all such examples, the exoskeleton will execute commands from the simulator system to provide gross motor virtual feedback to constrain motion at the exoskeleton that is responsive to the pilot's interactions with the virtual objects.

Advantageously, the present method and apparatus for gross motor virtual feedback supports a richly immersive and realistic simulation by enabling the exoskeleton pilot's interaction with the virtual environment to more closely match interactions with an actual physical environment. By providing for additional sensory stimulation through touch, the present gross motor virtual feedback enables a physical representation of objects to be enabled in a virtual environment to provide an extra dimension of realism. In addition, utilization of existing exoskeletons that can be adapted for use in simulations using gross motor virtual feedback enables the present advanced simulation techniques to be quickly and economically deployed in the field.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows a pictorial view of an illustrative exoskeleton as worn by a soldier that may be adapted to facilitate implementation of the present method and apparatus for gross motor virtual feedback;

FIG. 2 shows a side view of the illustrative exoskeleton shown in FIG. 1;

FIG. 3 shows an illustrative exoskeleton joint having three degrees of freedom of motion;

FIG. 4 shows a model of an illustrative one degree of freedom exoskeleton joint interacting with a pilot's leg;

FIG. 5 shows a block diagram of functional components of an illustrative exoskeleton including an interface to an external simulator system;

FIG. 6 shows a pictorial view of an illustrative simulation environment in which an exoskeleton implementing the present method and apparatus for gross motor virtual feedback may be utilized;

FIG. 7 shows an alternative simulator environment that utilizes an immersive CAVE (Cave Automatic Virtual Environment) configuration;

FIGS. 8 and 9 show an alternative simulator environment that utilizes a head mounted display;

FIG. 10 shows an illustrative arrangement in which a capture volume may be monitored for motion capture using an array of video cameras;

FIG. 11 shows a set of illustrative markers that are applied to a helmet worn by the pilot at known locations;

FIG. 12 shows an illustrative example of markers and light sources as applied to a long arm weapon at known locations;

FIG. 13 shows an illustrative architecture that may be used to implement a simulator system that may interact with an exoskeleton facilitating implementation of the present method and apparatus for gross motor virtual feedback;

FIGS. 14 and 15 show a simulation pilot wearing an illustrative exoskeleton interacting with a virtual environment that is supported by a simulator using the present method and apparatus for gross motor virtual feedback;

FIG. 16 shows an illustrative block diagram of a control system that may be utilized with an exoskeleton that includes two feedback loops;

FIG. 17 shows an illustrative block diagram of a control system that may be utilized with an exoskeleton that includes two feedback loops, one of which is a transfer function E that represents constraints imposed by objects such as walls and terrain that may be implemented in a virtual environment supported by a simulator; and

FIG. 18 is a flowchart of an illustrative method of operating a simulator system that is coupled to an exoskeleton using gross motor virtual feedback.

Like reference numerals indicate like elements in the drawings. Unless otherwise indicated, elements are not drawn to scale.

### DETAILED DESCRIPTION

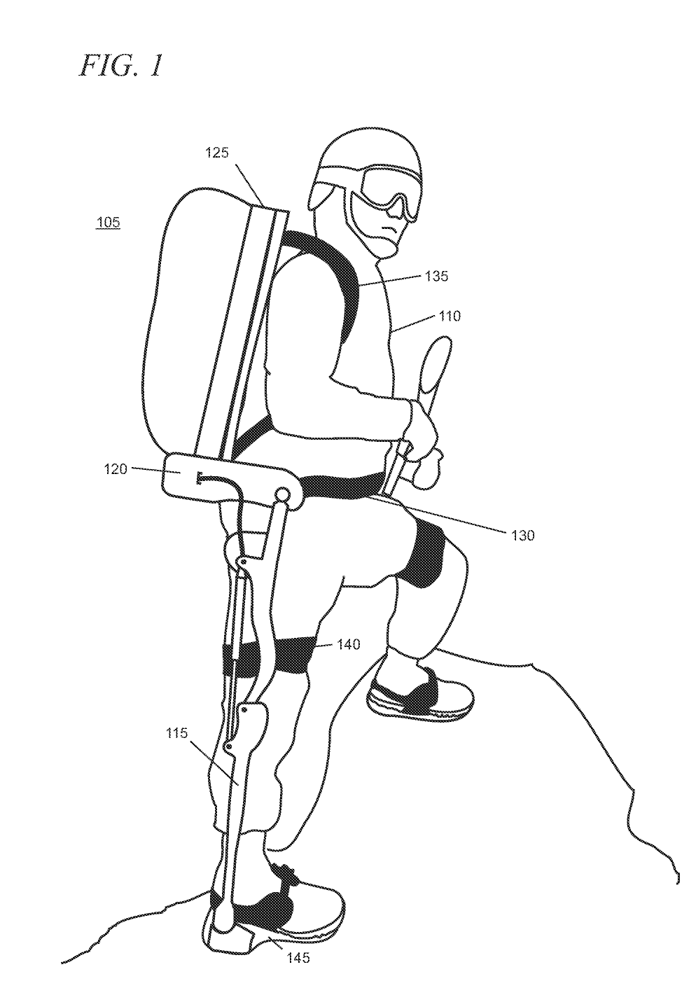

FIG. 1 shows a pictorial view of an illustrative exoskeleton 105 as worn by a pilot 110 (in this example, a soldier) that may be adapted to facilitate implementation of the present method and apparatus for gross motor virtual feedback. Exoskeleton 105 is representative of a class of power-assisted exoskeletons that are configured to augment, or amplify, human strength and endurance during locomotion. Exoskeleton 105 is termed a lower extremity exoskeleton that comprises a pair of powered pseudo-anthropomorphic legs 115 that are coupled to a hip module 120 that houses a power unit among other components, and a backpack-type frame 125 and upon which a variety of heavy loads may be mounted. The hip module 120 and frame 125 are attached to the pilot via a harness which may include a belt 130 and straps 135, respectively. The exoskeleton legs 115 are attached to the pilot's legs using straps 140 and include integrated footplates 145 that are strapped to the pilot's feet. Although a lower extremity exoskeleton 105 is shown in the drawings and described in the accompanying text, it is emphasized that the principles of gross motor virtual feedback articulated using this present illustrative example may be applicable, in some implementations and usage scenarios, to other types of exoskeletons including upper extremity exoskeletons and combinations of upper and lower extremity exoskeletons. In addition, un-powered exoskeletons may also be utilized for the present gross motor virtual feedback in some cases.

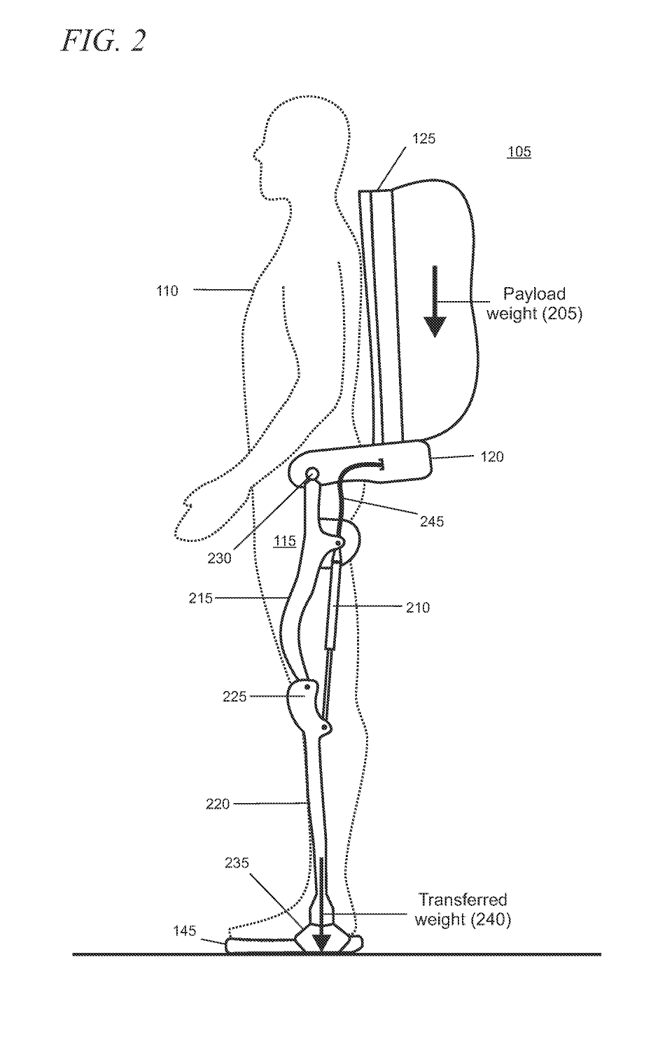

The exoskeleton 105 is typically configured to provide its pilot (i.e., soldier 110 in this example) with the capability to carry significant loads on his or her back with minimal effort over a wide variety of terrain types that would otherwise present difficulties to move using conventional wheeled transportation. As shown in FIG. 2, the weight of a payload 205 is effectively transferred through the frame 125 and hip module 120 to the legs 115 and footplates 145 and ultimately to the ground (as indicated by reference numeral 240). By bearing the payload weight, the exoskeleton 105 isolates the pilot 110 from the load. In combination with the actuators in each leg (represented by reference numeral 210 in FIG. 2) which provide the strength amplification for locomotion, the exoskeleton 105 provides load transparency to the pilot. In operation, the pilot can be expected to quickly adapt to the exoskeleton without extensive training or the need to learn any special type of interface to the exoskeleton. The pilot supplies the human intellect to provide balance, navigation, and path planning while the exoskeleton 105 and actuators 210 provide most of the strength necessary for supporting payload and walking.

The exoskeleton 105 is further configured to enable the pilot to comfortably squat, bend, swing from side to side, twist, and walk on ascending and descending slopes, while also offering the ability to step over and under obstructions while carrying equipment and supplies. Because the pilot can carry significant loads for extended periods of time without reducing his/her agility, physical effectiveness increases significantly with the aid of lower extremity exoskeletons. Exoskeletons typically have numerous applications: they can provide soldiers, disaster relief workers, wildfire fighters, and other emergency personnel the ability to carry and transport major loads such as food, rescue equipment, first-aid supplies, weaponry, and communications gear, without the strain typically associated with demanding labor. Commercially available exoskeletons that may be adapted for use with the present gross motor virtual feedback include, for example, the HULC™ (Human Universal Load Carrier) by Lockheed Martin Corporation.

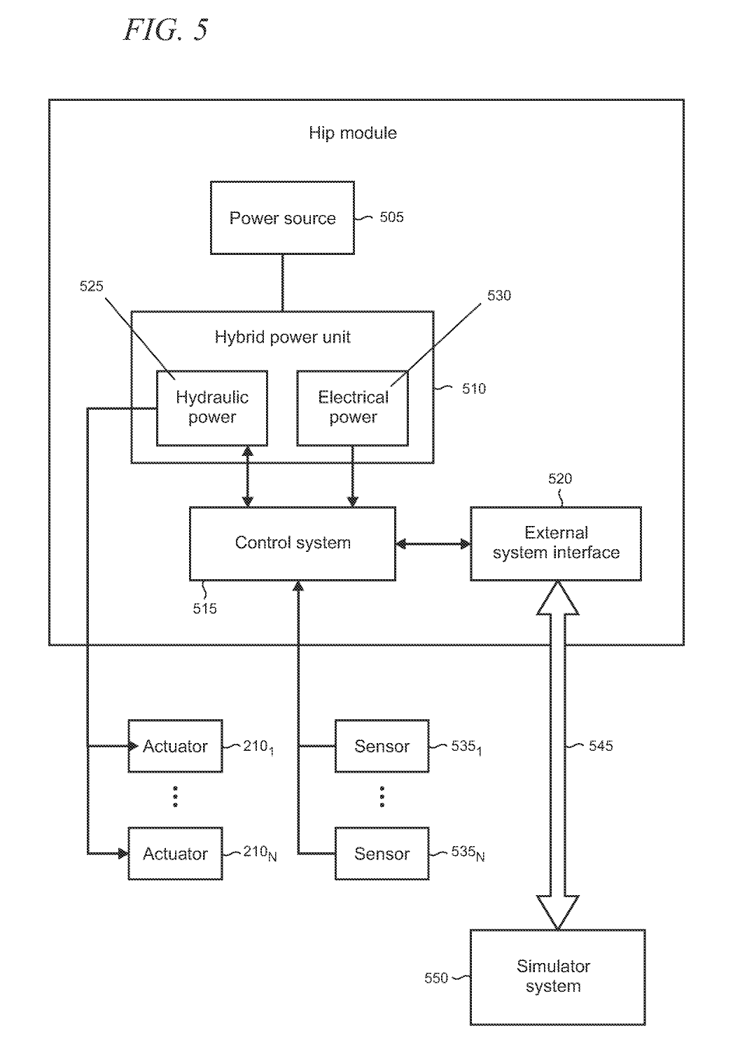

As shown in FIG. 2, each leg 115 comprises a set of links that are mechanically coupled via joints. In this example, each leg includes an upper leg portion 215 and lower leg portion 220 that respectively anthropomorphically correspond to the thigh and lower leg (i.e., shank) of the pilot 110. The upper leg portion 215 is coupled via a knee joint 225 to the lower leg portion 220 and is coupled to the hip module 120 via a hip joint 230. Each lower leg portion 220 is coupled to the footplate via an ankle joint 235. The actuator 210 is respectively moveably and rotatably coupled at either end to the upper leg portion 215 and lower leg portion 220 so that when actuated, a torque is applied at the knee joint 225. In this illustrative example of the exoskeleton, the actuator 210 is configured as a hydraulic cylinder that is coupled via a hydraulic supply hose 245 to a hybrid power unit, as described below in the text accompanying FIG. 5.

It is emphasized that exoskeletons using single actuators or multiple actuators are contemplated as being usable with the present method and apparatus for gross motor virtual feedback. In addition, actuators of various types, including for example electric, hydraulic, pneumatic, or combinations thereof, may also be utilized in particular applications. In this particular illustrative example, a hydraulic actuator is utilized for its high specific power (i.e., power to actuator weight ratio), its capability to produce large forces, and the high control bandwidth that is afforded via utilization of largely incompressible hydraulic fluid.

While anthropomorphic exoskeletons may be expected to be utilized in many typical applications of gross motor virtual feedback, the present method and apparatus is not necessarily limited to anthropomorphic exoskeletons. In some applications of gross motor virtual feedback, the use of non-anthropomorphic exoskeletons, pseudo-anthropomorphic exoskeletons, or exoskeletons having non-anthropomorphic portions can be expected to provide satisfactory results.

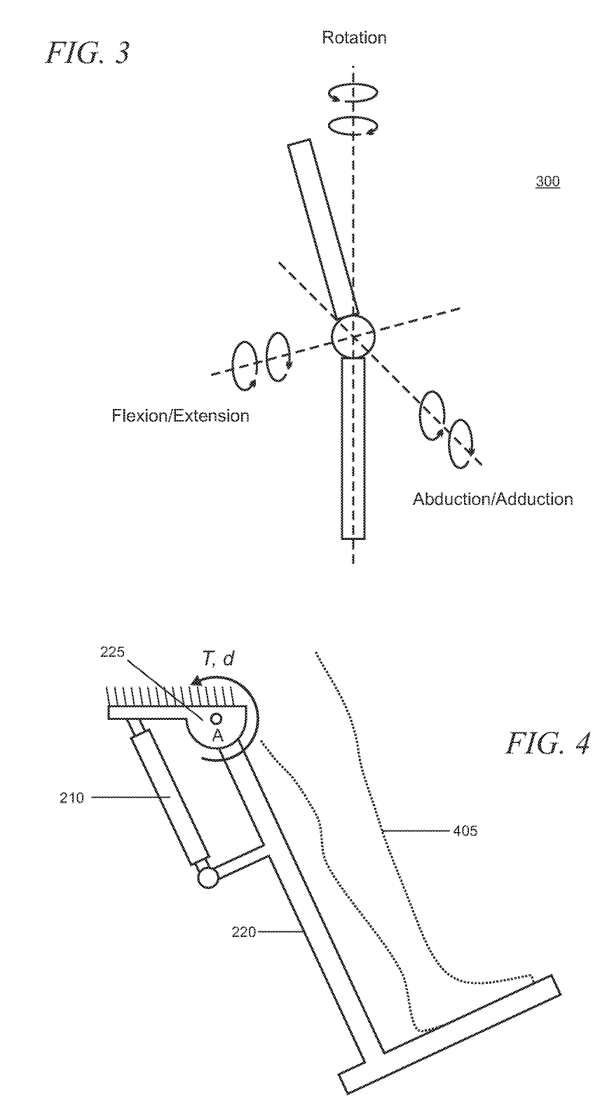

FIG. 3 shows an illustrative exoskeleton joint 300 having three degrees of freedom (“dof”) of motion. As shown, joint 300 supports rotation about three axes: x, y, and z, termed flexion/extension, abduction/adduction, and rotation, respectively. Human hip and ankle joints, for example, are three dof joints. Other human joints such as the knee have more complex motions and combine rolling and sliding along with rotation. In this illustrative example, the exoskeleton 105 is configured with seven distinct dof per leg: three dof at the joint between each leg 115 and the hip module 120; one dof at each knee joint 225; and three dof at each ankle joint 235. As the knee joint 225 in exoskeleton 105 supports one dof (flexion/extension only in the sagittal plane), the exoskeleton 105 is typically characterized as pseudo-anthropomorphic as it provides similar kinematics to the human leg, but does not include all of the dof of motion of a human leg.

FIG. 4 shows a model of an illustrative one dof exoskeleton knee joint 225 and lower leg portion 220 interacting with a pilot's leg 405 that provides for flexion/extension in the sagittal plane. Typically, the pilot is attached to the exoskeleton leg 115 at the foot, thigh, and lower leg (as shown in FIG. 1) to thereby impose force and torque about the joint 225 at the pivot point A in the drawing. The locations of the contact points between the pilot and the exoskeleton leg and the direction of the contact forces and torques can vary. However, the total equivalent torque associated with all the forces and torques from the pilot is represented by d in FIG. 4. Under the control of a controller located in the hip module 120 (FIG. 1) the hydraulic actuator 210 produces a torque T about the pivot point A.

Details of illustrative functional components for powering and controlling the exoskeleton 105 are shown in FIG. 5. As shown, the hip module 120 includes various functional components including a power source 505, hybrid power unit 510, a control system 515, and an external system interface 520. The power source is typically configured using one or more batteries (such as lithium polymer batteries) or fuel cells. In some implementations, the power source 505 may be supplemented or replaced with sources that are disposed as a portion of the payload that is supported by the frame 125. Alternatively, a power source that is located externally to the exoskeleton 105 can be utilized in some implementations and usage scenarios. For example, the exoskeleton 105 may be configured to utilize a tether to an external power source. In some cases, the tether could also transport signals such as control and feedback signals between a simulator and the exoskeleton 105.

As shown in FIG. 5, the power source 505 is operatively coupled to a hybrid power unit 510. The hybrid power unit 510 is configured to provide both hydraulic power 525 to the actuators 210_{1 . . . N} and electrical power 530 that is used by the control system 515 and other electronics (not shown) that may be used by the exoskeleton 105, as well as one or more sensors 535_{1 . . . N}. The sensors 535 are typically disposed at various locations of the exoskeleton and are generally configured to detect a position or velocity of exoskeleton components (e.g., the links and/or joints), or the forces applied thereto either by the pilot or by external forces, including for example, gravity.

The external system interface 520 is arranged to enable the exoskeleton 105 to be operatively coupled via a communication link 545 to a simulator system 550. The communication link 545 may be configured as a wireless link using a wireless communication protocol such as IEEE 802.11 (Institute of Electrical and Electronics Engineers). Alternatively, a hardwire communication link may be utilized, for example, in implementations in which the exoskeleton 105 is tethered to external systems.

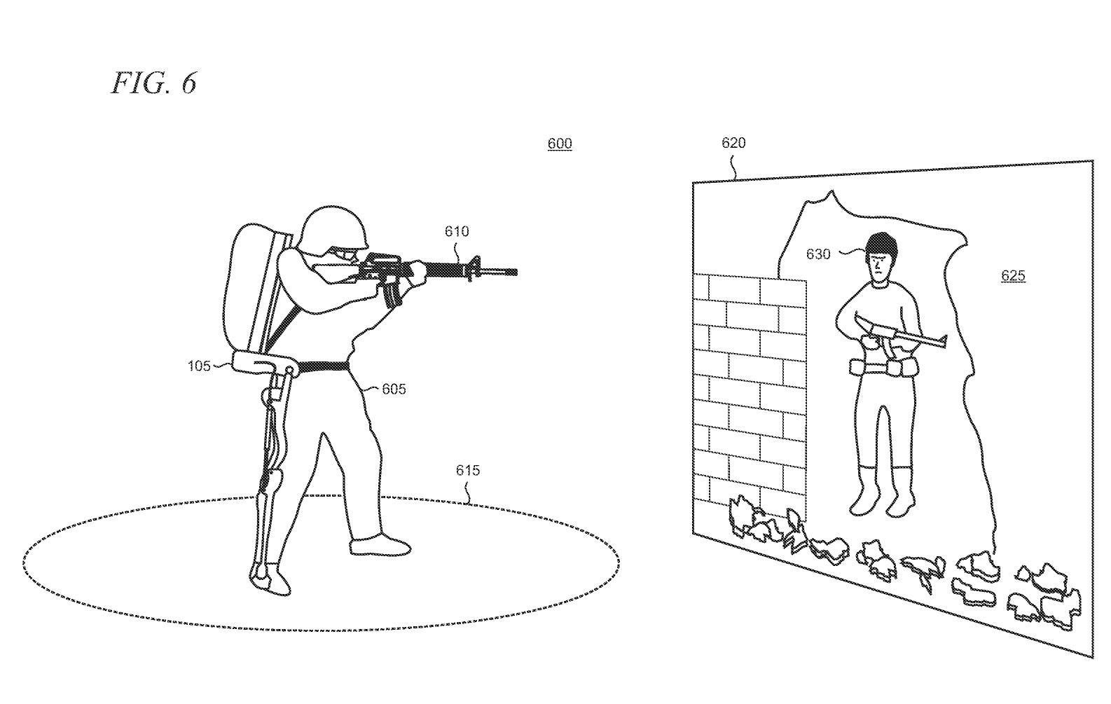

FIG. 6 shows a pictorial view of an illustrative simulation environment 600 that may be facilitated through utilization of the simulator system 550 (FIG. 5). The simulation environment 600 supports a participant (here, a pilot 605 wearing the exoskeleton 105 as shown in FIG. 1) in the simulation. In this particular illustrative example, the pilot 605 is a single soldier using a simulated weapon 610, who is engaging in training that is intended to provide a realistic and immersive shooting simulation. It is emphasized, however, that the simulator system is not limited to military applications or shooting simulations. The present simulator system may be adapted to a wide variety of usage scenarios including, for example, industrial, emergency response/911, law enforcement, air traffic control, firefighting, education, sports, commercial, engineering, medicine, gaming/entertainment, and the like. In some of these scenarios weapons are not supported. The simulation environment 600 may also support multiple participants if needed to meet the needs of a particular training scenario.

As shown in FIG. 6, the pilot 605 trains within a space (designated by reference numeral 615) that is termed a “capture volume.” The pilot 605 is typically free to move within the capture volume 615 as a given training simulation unfolds. Although the capture volume 615 is indicated with a circle in FIG. 6, it is noted that this particular shape is arbitrary and various sizes, shapes, and configurations of capture volumes may be utilized as may be needed to meet the requirements of a particular implementation. As described in more detail below, the capture volume 615 is monitored, in this illustrative example, by an optical motion capture system. Motion capture is also referred to as “motion tracking” Utilization of such a motion capture system enables the simulator system 550 to maintain knowledge of the position and orientation of the pilot 605 and weapon 610 as the pilot moves through the capture volume 615 during the course of the training simulation. It is noted that the weapon tracking does not need to be performed in all implementations of gross motor virtual feedback and is thus optionally utilized.

A simulation display screen 620 is also supported in the environment 600. The display screen 620 provides a dynamic view of a virtual environment 625 that is generated by the simulator system 550. Typically a video projector is used to project the view of the virtual environment 625 onto the display screen 620, although direct view systems using flat panel emissive displays can also be utilized in some applications. In FIG. 6, the virtual environment 625 shows a snapshot of an illustrative avatar 630, that in this example is part of an enemy force and thus a target of the shooting simulation. An avatar is typically a model of a virtual person who is generated and animated by the simulator system. In some applications, the avatar 630 may be a representation of an actual person (i.e., a virtual alter ego), and could take any of a variety of roles such as a member of a friendly or opposing force, a civilian non-combatant, etc. Furthermore, while a single avatar 630 is shown in the view of the virtual environment 625, the number of avatars utilized in any given simulation can vary as needs dictate.

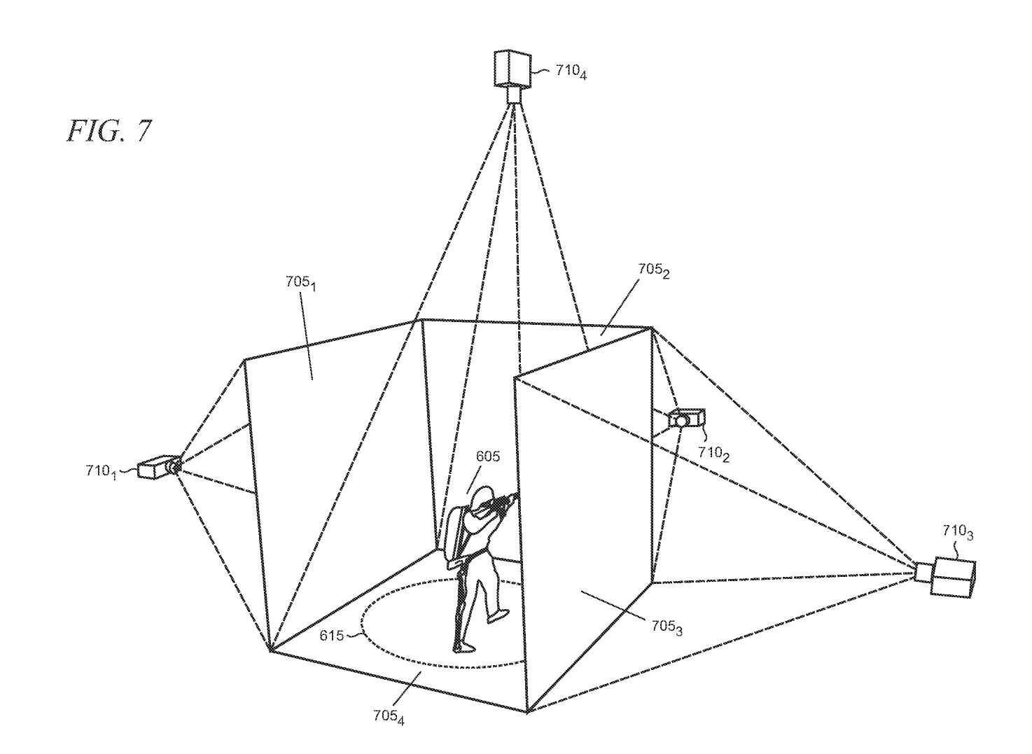

The simulation environment 600 shown in FIG. 6 is commonly termed a “shoot wall” because a single display screen is utilized in a vertical planar configuration that the pilot 605 faces to view the projected virtual environment 625. However, the present simulator system is not necessarily limited to shoot wall applications and can be arranged to support other configurations. For example, as shown in FIG. 7, a CAVE configuration may be supported in which four non-co-planar display screens 705_{1, 2 . . . 4} are typically utilized to provide a richly immersive virtual environment that is projected across three walls and the floor. As the projected virtual environment substantially surrounds the pilot 605, the capture volume 615 is coextensive with the space enclosed by the CAVE projection screens, as shown in FIG. 7.

In some implementations of CAVE, the display screens 705_{1, 2 . . . 4} enclose a space that is approximately 10 feet wide, 10 feet long, and 8 feet high; however, other dimensions may also be utilized as may be required by a particular implementation. The CAVE paradigm has also been applied to fifth and/or sixth display screens (i.e., the rear wall and ceiling) to provide simulations that may be even more encompassing for the pilot 605. Video projectors 710_{1, 2 . . . 4} may be used to project appropriate portions of the virtual environment onto the corresponding display screens 705_{1, 2 . . . 4}. In some CAVE simulators, the virtual environment is projected stereoscopically to support 3D observations for the pilot 605 and interactive experiences with substantially full-scale images.

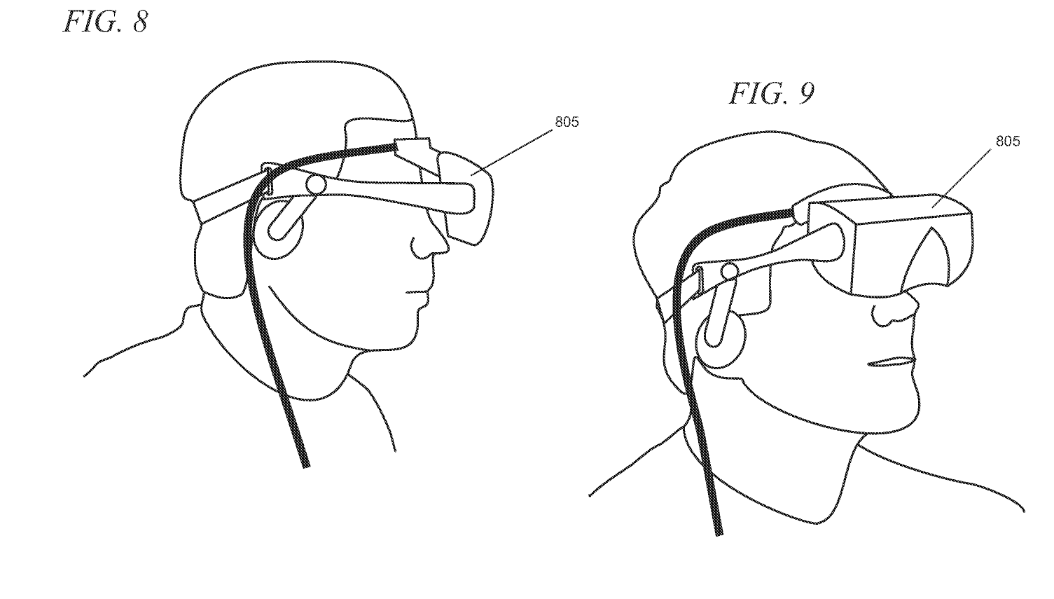

Another alternative to the shoot wall simulation environment can be provided through use of a head mounted display 805, as shown in FIGS. 8 and 9. The head mounted display 805 includes display screens (not shown) that are positioned in view of the user's eyes and which project a virtual environment. Typically, the projected virtual environment will change as the user moves his or her head and/or changes position within the capture volume 615. In other words, the projected virtual environment dynamically matches the user's point of view so that the simulation is richly immersive. In some head mounted display designs, the display screens include separate left-eye and right-eye displays with different images so that the user views the projected virtual environment stereoscopically.

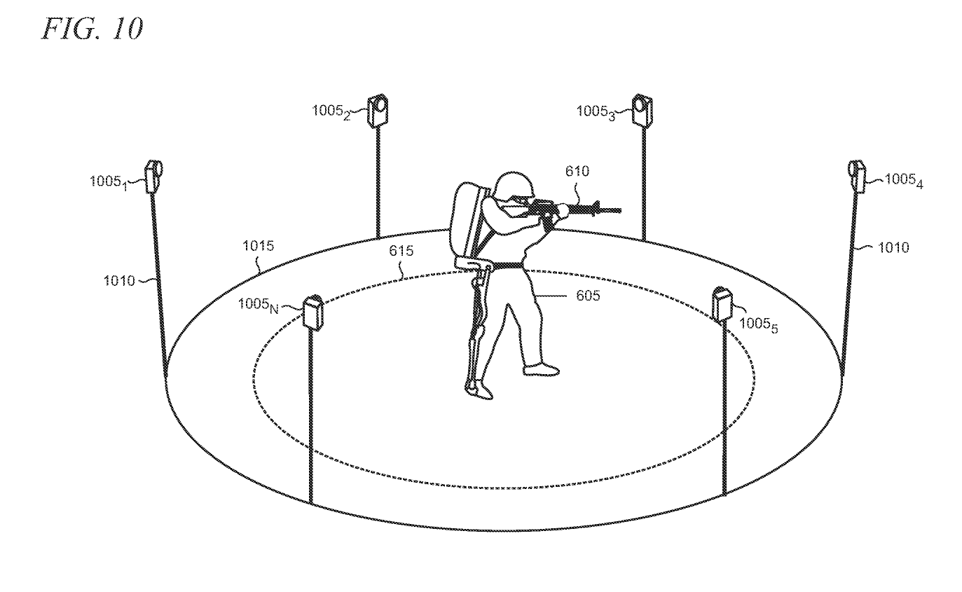

The position and orientation (i.e., “pose”) of the pilot 605 within the capture volume 615 will typically be tracked in order to facilitate the gross motor virtual feedback to the pilot as he or she interacts with the virtual environment. As shown in FIG. 10, the capture volume 615 is within the field of view of an array of multiple video cameras 1005_{1, 2 . . . N} that are part of an optical motion capture system so that the position and orientation of the pilot 605 and weapon 610 (FIG. 6) may be tracked within the capture volume as the pilot moves as a simulation unfolds. However, it is emphasized that a variety of alternative techniques may also be utilized to implement tracking depending on the needs of a particular implementation of gross motor virtual feedback. For example, known motion capture techniques such as mechanical (i.e., prosthetic), acoustic, or magnetic motion capture may be suited to some applications.

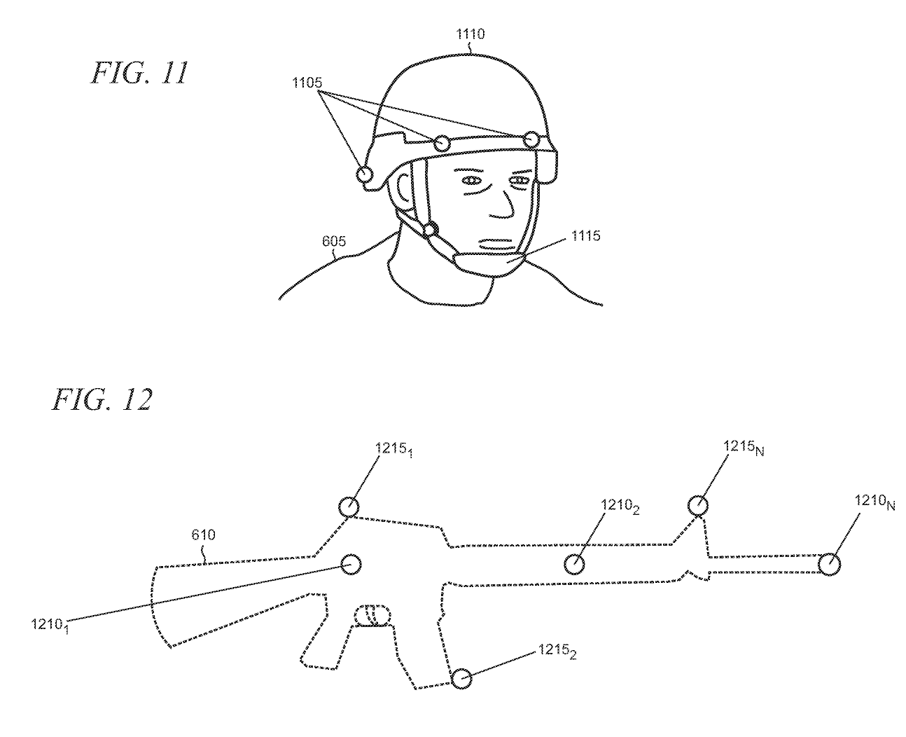

Optical motion tracking typically utilizes images of markers that are captured by the video cameras 1005. As shown in FIGS. 11 and 12, the markers are placed on the pilot 605 and weapon 610 at known locations. The centers of the marker images are matched from the various camera views using triangulation to compute frame-to-frame spatial positions of the pilot 605 and weapon 610 within the 3D capture volume 615.

FIG. 11 shows a set of illustrative markers 1105 that are applied to a helmet 1110 worn by the pilot 605 and secured with a chinstrap 1115. In alternative implementations, the markers 1105 can be applied to hat, headband, skullcap or other relatively tight-fitting device/garment so that the motions of the markers closely matches the motions of pilot (i.e., extraneous motion of the markers is minimized). The markers 1105 are used to dynamically track the position and orientation of the pilot's head during interaction with a simulation. Additional markers (not shown) may also be applied to the pilot 605, for example, using a body suit, harness, or similar device, to enable full body tracking within the capture volume 615. Alternatively, markers may be affixed to portions of the exoskeleton 105.

The markers 1105 are substantially spherically shaped in many typical applications and formed using retro-reflective materials which reflect incident light back to a light source with minimal scatter. The number of markers 1105 utilized in a given implementation can vary. The markers 1105 are rigidly mounted in known locations to enable the triangulation calculation to be performed to determine position and orientation of the pilot within the capture volume 615. Additional markers 1105 may be utilized in some usage scenarios to provide redundancy when markers would otherwise be obscured during the course of a simulation (for example, the pilot lies on the floor, ducks behind cover when so provided in the capture volume, etc.), or to enhance tracking accuracy and/or robustness in some cases.

In some implementations, the sensors 535 integrated with the exoskeleton 105 can be configured to provide data to the simulator system 550 that may be used to determine position and orientation of the pilot 605 within the capture volume on either a full body or partial body basis. Alternatively, the sensors 535 may also be utilized to supplement the tracking data from the tracking system to enhance the data or add robustness or redundancy. In some implementations, the sensors 535 may be specially adapted to provide tracking data to the simulator system 550, either alone, or in combination with tracking data that is provided by a motion capture system.

FIG. 12 shows an illustrative example of markers as applied to the simulated weapon 610 shown in FIG. 6 when a weapon is supported in a particular simulation. Simulated weapons are typically similar in appearance and weight as their real counterparts, but are not capable of firing live ammunition. In some cases, simulated weapons are real weapons that have been appropriately reconfigured and/or temporarily modified for simulation purposes. In this example, markers 1210₁, 1210₂, and 1210_{N} are located along the long axis defined by the barrel of the weapon 610 while markers 1215₁, 1215₂, and 1215_{N} are located off the long axis. Generally, at least two markers 1210 located along the long axis of the weapon can be utilized in typical applications to track the position of the weapon 610 in the capture volume 615 and implement the binary signaling capability.

Returning again to FIG. 10, stands, trusses, or similar supports, as representatively indicated by reference numeral 1010, are typically used to arrange the video cameras 1005 around the periphery 1015 of the capture volume 615. The number of video cameras N may vary from 6 to 24 in many typical applications. While fewer cameras can be successfully used in some implementations, six is generally considered to be the minimum number that can be utilized to provide accurate head tracking since tracking markers can be obscured from a given camera in some situations depending on the movement and position of the pilot 605. Additional cameras are typically utilized to provide full body tracking, additional tracking robustness, and/or redundancy.

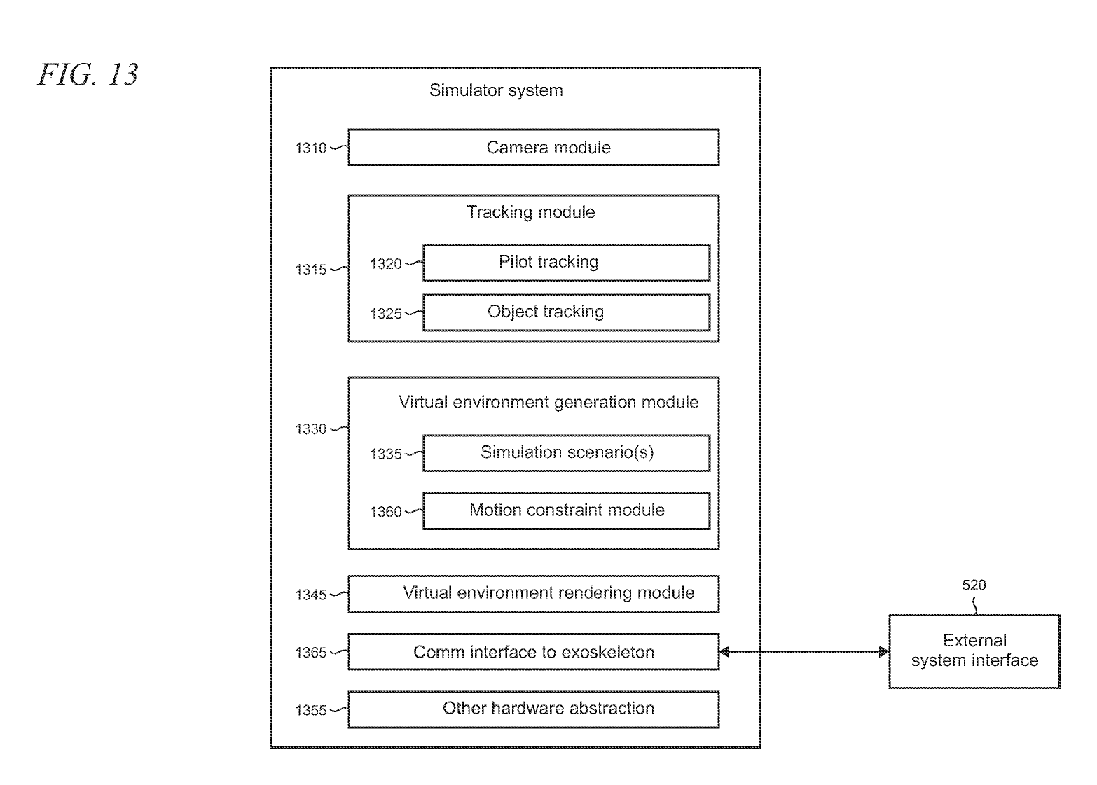

FIG. 13 shows an illustrative architecture that may be used to implement the simulator system 550. In some applications, the simulator system 550 is configured to operate using a variety of software modules embodied as instructions on computer-readable storage media, described below, that may execute on general-purpose computing platforms such as personal computers and workstations, or alternatively on purpose-built simulator platforms. In other applications, the simulator system 550 may be implemented using various combinations of software, firmware, and hardware. In some cases, the simulator system 550 may be configured as a plug-in to existing simulators in order to provide the enhanced gross motor virtual feedback functionality described herein. For example, the simulator system 550 when configured with appropriate interfaces may be used to augment the training scenarios afforded by an existing ground combat simulation to make them more realistic and more immersive.

The camera module 1310 is utilized to abstract the functionality provided by the video cameras 1005 (FIG. 10) which are used to monitor the capture volume 615 (FIG. 6). Typically the camera module 1310 will utilize an interface such as an API (application programming interface) to expose functionality to the video cameras 1005 to enable operative communications over a physical layer interface, such as USB. In some applications, the camera module 1310 may enhance the native motion capture functionality supported by the video cameras 1005, and in other applications the module functions essentially as a pass-through communications interface.

A tracking module 1315 is also included in the simulator system 550 and will typically include a pilot tracking module 1320 as well as an optionally utilized object tracking module 1325. The pilot tracking module 1320 uses images of the helmet and/or body markers captured by the camera module 1310 in order to triangulate the position of the pilot 605 within the capture volume 615 as a given simulation unfolds and the pilot moves throughout the volume. In this illustrative example, tracking of the position and orientation of the exoskeleton 105 within the capture volume 615 (FIG. 6) is implemented. However, in alternative implementations, head tracking alone is utilized in order to minimize the resource costs and latency that is typically associated with more comprehensive tracking and the position of the exoskeleton 105 is inferred from the position of the head.

Similarly, an object tracking module 1325 is included in the simulator system 550 which uses images of the weapon markers captured by the camera module 1310 to triangulate the position of the weapon 610 within the capture volume 615. For both pilot tracking and object tracking, the position determination is performed substantially in real time to minimize latency as the simulator system generates and renders the virtual environment. Minimization of latency can typically be expected to increase the realism and immersion of the simulation.

The simulator system 550 further supports the utilization of a virtual environment generation module 1330. This module is responsible for generating a virtual environment responsive to a particular simulation scenario as indicated by reference numeral 1335. A virtual environment rendering module 1345 is utilized in the simulator system 550 to take the generated virtual environment and pass it off in an appropriate format for projection or display on the display screen 620 or other display device that is utilized. As described above, multiple views and/or multiple screens may be utilized as needed to meet the requirements of a particular implementation.

Other hardware may be abstracted in a hardware abstraction layer 1355 in some cases in order for the simulator system 550 to implement the necessary interfaces with various other hardware components that may be needed to implement a given simulation. For example, various other types of peripheral equipment may be supported in a simulation, or interfaces may need to be maintained to support the simulator system 550 across multiple platforms in a distributed computing arrangement.

The virtual environment generation module 1330 further includes a motion constraint module 1360 that may be utilized to dynamically generate one or more commands that are transmitted via a communication interface 1365 to the external system interface 520 (FIG. 5) of the exoskeleton 105 to thereby control its motion responsively to the virtual environment. That is, the motion constraint module 1360 uses the generated virtual environment in a given simulation scenario as virtual external stimuli to the motion and position of the exoskeleton 105 within the capture volume 615. In this way, the exoskeleton 105 enables the pilot 605 to interact with the virtual environment not only visually but also through gross motor virtual feedback from the exoskeleton. Thus, the pilot 605 can see, as well as feel objects, in the virtual environment.

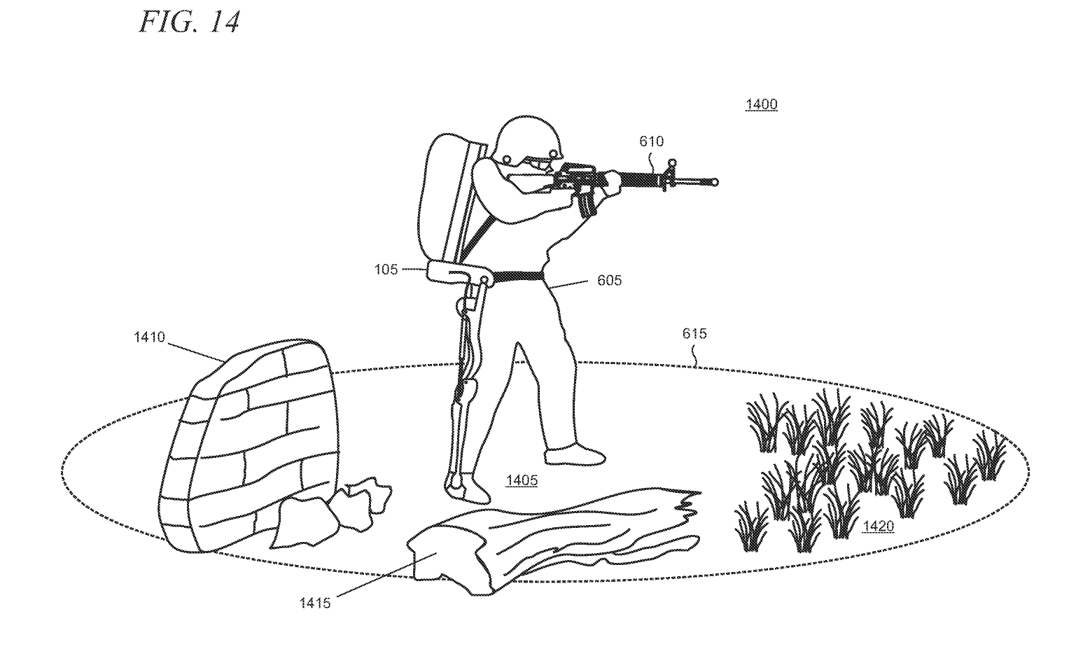

FIG. 14 shows an illustrative example of a virtual environment 1400 generated in a particular simulation scenario. In this example, a variety of virtual objects 1405 are generated and virtually positioned within the capture volume 615. The virtual objects 1405 include, in this example, a wall 1410, log 1415, and marshy terrain 1420. It is emphasized that these particular virtual objects are illustrative and that other virtual objects may be generated and utilized in accordance with the needs of a specific application of gross motor virtual feedback. The virtual objects 1405 may be displayed to the pilot 605 using one or more of the display techniques shown in FIGS. 6-9 and described in the accompanying text. As the pilot 605 moves within the virtual environment 1400, the pilot can interact with the virtual objects 1405 by touch and feel as enabled by gross motor virtual feedback from the exoskeleton 105.

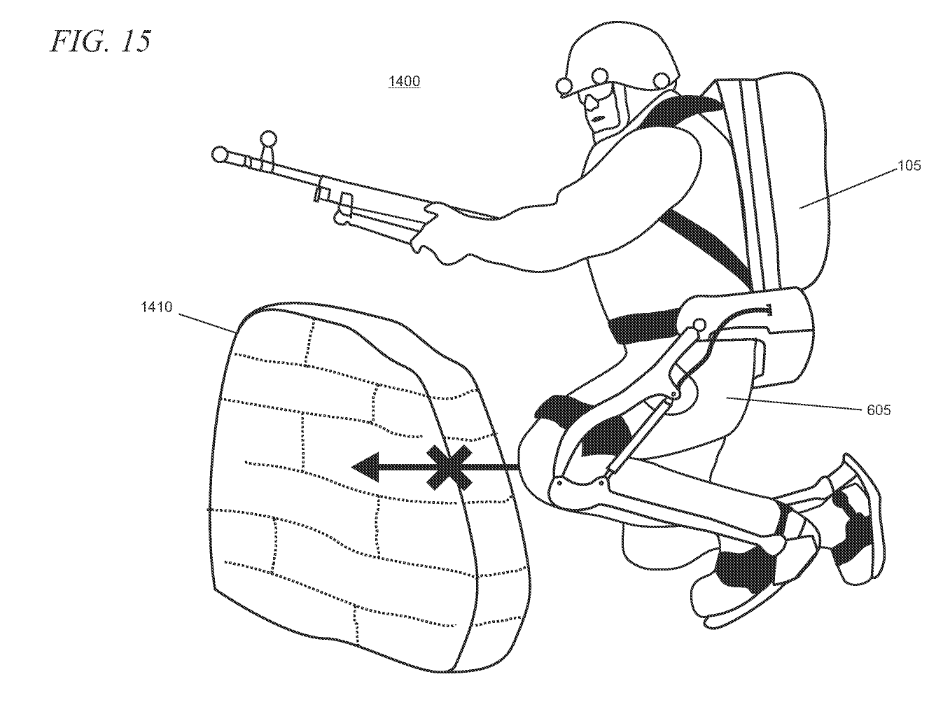

For example, as shown in FIG. 15, as the pilot 605 approaches the virtual wall 1410 in the virtual environment 1400, the exoskeleton 105 will receive a command from the simulator system 550 to constrain the motion of the pilot 605. In this example, the exoskeleton 105 stops the pilot's knee from moving forward at the virtual wall 1410. In a similar manner, commands from the simulator system 550 may be configured to constrain motion so that the pilot 605 can interact and feel other the virtual objects 1405 in the virtual environment 1400. For example, the pilot 605 would need to step over the log 1415 because the exoskeleton 105 would otherwise be commanded to prevent the pilot from walking through it. If the pilot 605 wanted to kick the log 1415 aside to clear an area of obstacles to set up a weapon, the exoskeleton 105 would provide the responsive gross motor virtual feedback to simulate the mass of the log when pushed by the pilot's leg. When the pilot 605 encounters the marshy terrain 1420, the exoskeleton would be commanded to increase the force and exertion of the pilot 605 required to lift his or her legs as the pilot traverses the marshy terrain. This increase in pilot force would simulate the feeling of the suction effect that is commonly encountered when walking in mud, muck, and other highly viscous substances.

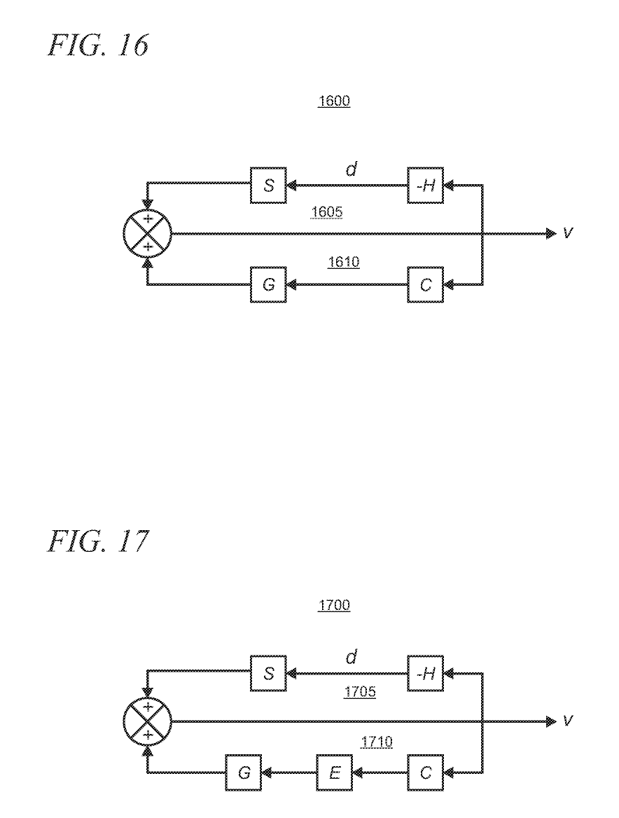

FIG. 16 shows an illustrative block diagram of a control system 1600 that may be utilized with a given joint of the exoskeleton 105 that includes two feedback loops 1605 and 1610. Control system 1600 is typically utilized to provide force amplification of the pilot's forces. The pilot force on the exoskeleton 105, d, is a function of the pilot dynamics, H, and kinematics of the pilot's limb, for example, its position, velocity, or combination thereof where d=−H(v). The sensitivity transfer function, S, represents how the equivalent pilot torque, d, affects the angular velocity of a link around the joint. Typically, S is selected so that exoskeleton 105 has large sensitivity to the forces and torques from the pilot 605. The upper feedback loop 1605 in FIG. 16 thus shows how the forces and torques from the pilot 605 move the exoskeleton 105.

The lower feedback loop 1610 shows how the control system 515 (FIG. 5) drives the exoskeleton 105 through its transfer function C where G represents the transfer function from the input to the actuator 210. Typically to achieve the desirable large sensitivity function, C may be selected as the inverse of the exoskeleton dynamics G, for example C=−0.9G⁻¹ which results in a 10× force amplification of the pilot forces. While the lower feedback loop 1610 containing C is positive, the upper feedback loop 1605 containing H stabilizes the overall system of pilot and exoskeleton taken as a whole.

FIG. 17 shows an illustrative block diagram of a control system 1700 that may be utilized with the exoskeleton 105 when adapted to facilitate the present gross motor virtual feedback. In this example, the control system includes a transfer function E in the lower feedback loop 1710 that represents constraints to motion and position that are imposed by virtual objects such as walls and terrain in a virtual environment. The controller transfer function C can then be selected to enable the sensitivity transfer function S to be at unity (or negative) so that v is reduced or approaches zero as the pilot 605 interacts with the virtual environment of a given simulation.

It is noted that the commands generated by the motion constraint module 1360 (FIG. 13) as applied by the control system 1700 can be expected to control the exoskeleton 105 in a manner that maximizes the safety of the pilot 605 in most typical applications. That is, the magnitude of gross motor virtual feedback provided to the pilot will typically be set at a sufficient level so that the pilot can interact with and sense the virtual object by touch, but not so high as to cause injury by constraining the pilot's motion too abruptly or by unduly limiting the pilot's range of motion.

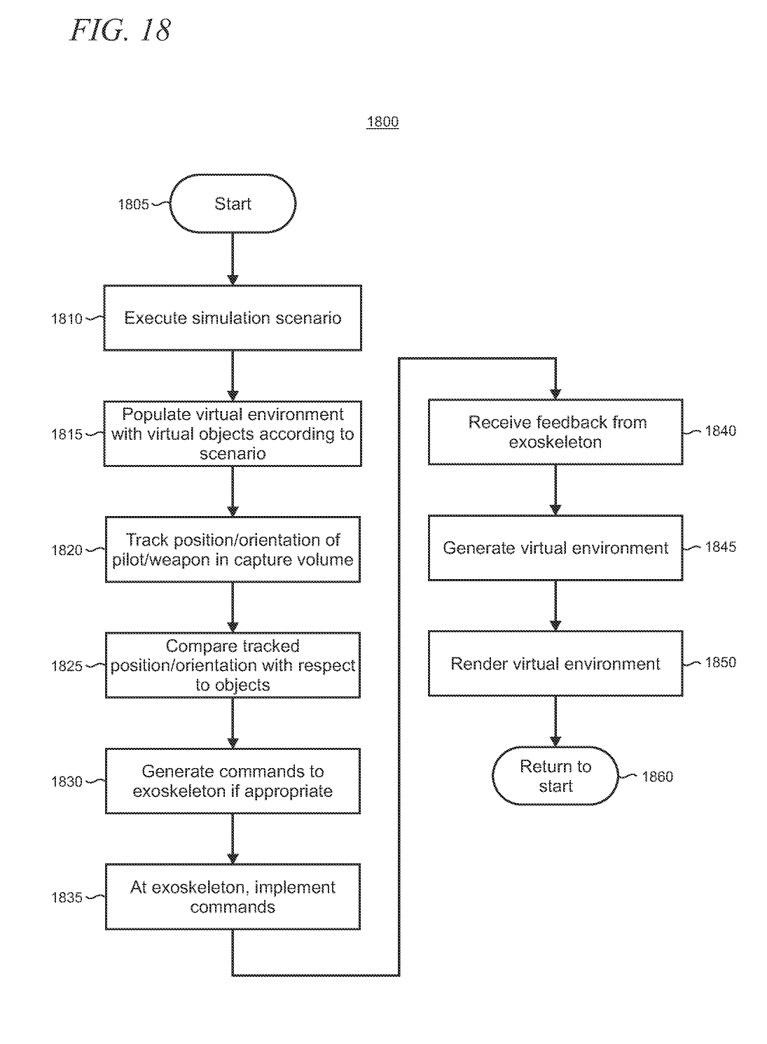

FIG. 18 is a flowchart of an illustrative method 1800 of operating the simulator system 550 (FIG. 5) that is coupled to the exoskeleton 105 to facilitate gross motor virtual feedback. The method starts at block 1805. At block 1810 a particular simulation scenario 1335 (FIG. 13) is loaded and executed. At block 1815, the virtual environment generation module generates a virtual environment that is populated by virtual objects (e.g., virtual objects 1405 in FIG. 14) responsively to the simulation scenario 1335. At block 1820, the position and orientation of the pilot 605 and/or weapon 610 (FIG. 6) are tracked using a system such as an optical motion capture system.

The tracked position and orientation are compared against the locations of the virtual objects in the virtual environment at block 1825. At block 1830, if the comparison indicates that the pilot 605 or weapon 610 is interacting with a virtual object, the motion constraint module 1360 can generate one or more appropriate commands to be executed by the exoskeleton 105 at block 1835. Typically, feedback as to the extent of the implementation of the motion constraint at the exoskeleton 105 can be generated and then received by the simulator system 550, as indicated at block 1840. Such feedback can be captured via motion tracking or sensed directly by the exoskeleton sensors 535. The simulator system will generate the virtual environment and then render it on an appropriate display, as respectively indicated at blocks 1845 and 1850. At block 1860 control is returned back to the start and the method 1800 is repeated. The rate at which the method repeats can vary by application, however, the various steps in the method will be performed with sufficient frequency to provide a smooth and seamless simulation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for operating a simulation supported on a simulator system, the method comprising the steps of:
tracking a participant in the simulation to determine at least one of position, orientation, or motion of the participant within a capture volume, the capture volume being monitored by a motion capture system, the participant operating an exoskeleton;
dynamically comparing the determined position, orientation, or motion of the participant to locations of one or more virtual objects in the virtual environment; and
constraining the position, orientation, or motion of the exoskeleton to supply gross motor virtual feedback to the participant responsively to the comparing.

2. The method of claim 1 in which the constraining is at least partially implemented by controlling one of sensitivity transfer function or control transfer function of the exoskeleton.

3. The method of claim 1 including a further step of generating a control signal at the simulator system to implement the constraining.

4. The method of claim 1 including a further step of transmitting the control signal to the exoskeleton via a communications link.

5. The method of claim 4 in which the communications link is one of wireless communication link or wired communication link.

6. The method of claim 1 in which the motion capture system is an optical motion capture system utilizing an array of video cameras.

7. The method of claim 1 in which the motion capture system is selected from one of mechanical motion capture, acoustic motion capture, or magnetic motion capture.

8. The method of claim 1 in which the exoskeleton includes one or more sensors configured to sense a position or velocity of respective one or more links in the exoskeleton and including a further step of transmitting link position or link velocity data collected from the one or more sensors to the simulator system.

9. A computer-implemented method for operating an exoskeleton worn by a pilot, the method comprising the steps of:
implementing a control system in the exoskeleton to control the motion of the exoskeleton in response to a total equivalent torque applied to the exoskeleton by the pilot;
receiving a command from a simulator system to constrain the motion of the exoskeleton so that gross motor virtual feedback is imparted from the exoskeleton to the pilot, the command being responsive to interaction of the pilot with a virtual environment that is generated by the simulator system; and
executing the command by adjusting the control system to control the motion of the exoskeleton responsively to the simulator system so that the pilot's motion is constrained.

10. The computer-implemented method of claim 9 including a further step of providing feedback from the exoskeleton to the simulator, the feedback indicating an extent of constraint being implemented at the exoskeleton responsively to the command.

11. The computer-implemented method of claim 9 in which the virtual environment is rendered utilizing a display device comprising multiple walls in a CAVE configuration.

12. The computer-implemented method of claim 9 in which the virtual environment is rendered utilizing a display device comprising a head mounted display.

13. The computer-implemented method of claim 9 in which the virtual environment is rendered utilizing a display device comprising a shoot wall.

14. The computer-implemented method of claim 9 in which the exoskeleton is a lower extremity exoskeleton.

15. One or more computer-readable storage media containing instructions which, when executed by one or more processors disposed in a computing device, implement a simulator system, the instructions being logically grouped in modules, the modules comprising:
a virtual environment generation module for generating a virtual environment supported by the simulator system, the virtual environment being populated with one or more virtual objects in accordance with a simulation scenario running on the simulator system;
a motion tracking module for determining position, orientation, or motion of a pilot wearing an exoskeleton within a capture volume of a simulation and for capturing interaction between the pilot and the one or more virtual objects; and
a motion constraint module for generating commands executable by the exoskeleton for constraining position, orientation, or motion of the exoskeleton, the commands being generated responsively to the captured interaction.

16. The one or more computer-readable storage media of claim 15 further comprising a virtual environment rendering module for rendering the generated virtual environment onto a display.

17. The one or more computer-readable storage media of claim 15 further comprising a communications interface for facilitating data exchange between the simulator system and the exoskeleton.

18. The one or more computer-readable storage media of claim 15 in which the exoskeleton is anthropomorphic or pseudo-anthropomorphic.

19. The one or more computer-readable storage media of claim 15 in which the tracking module is arranged to interface with an optical motion capture system utilizing one or more retro-reflective markers that are applied to the pilot or exoskeleton.

20. The one or more computer-readable storage media of claim 15 in which the motion constraint commands are executed at the exoskeleton by reducing transfer function sensitivity at an exoskeleton control system.
